(19) United States
(12) Patent Application Publication
(10) Pub. No.: US 2011/0231294 A1
(43) Pub. Date: Sep. 22, 2011

(54) Licensed Electronic Investment Portfolio Management Bidding System

(76) Inventor: Christopher Carter Fleetwood McClelland, Oxford, MS (US)

(21) Appl. No.: 13/050,868

(22) Filed: Mar. 17, 2011

Related U.S. Application Data
(60) Provisional application No. 61/314,814, filed on Mar. 17, 2010.

(51) Int. Cl. G06Q 40/00

(52) U.S. Cl. 705/35

(57) ABSTRACT

A licensed electronic investment portfolio management bidding system comprises of a website interface allowing an owner of investment portfolios to list their investment portfolio in a directory or post the investment portfolio in an investment marketplace. Approved financial advisors may submit requests to manage an investment portfolio listed or bid on a listed investment portfolio. The portfolio owner awards management to a financial advisor and transfers ownership of the portfolio to a controlling company which grants access to the awarded financial advisor. The present invention allows an investment portfolio owner to place their investment portfolio up to be competed for by financial advisors.

The current application claims a priority to the U.S. Provisional Patent application Ser. No. 61/314,814 filed on Mar. 17, 2010.

### FIELD OF THE INVENTION

The invention relates generally to a classifieds and bidding system which allows owners of investment portfolios to post their investment portfolios for financial or investment advisors to bid on. More particularly, winning bidder receives access to the owner's portfolio in order to manage it.

### BACKGROUND OF THE INVENTION

In the financial world, investors want to maximize the returns on their investments. To ensure they are making educated investing decisions, people often consult in financial advisors or investment advisors from financial firms. However, advisors may charge a significant fee for this valuable information and advice. The present invention allows investors to post their financial portfolios on a website to be bid on by competing financial companies interested in representing the investor. The bidding process determines the winner by whoever has bid the lowest cost of consultation. This invention will help investors save money and make the most out of their investments.

### SUMMARY OF THE INVENTION

A licensed electronic investment portfolio management bidding system allows a investor to electronically submit a portion of or their entire portfolio of investments such as bonds, CDs, IRAs, retirement accounts, real estate, stocks, etc to a group of bidders such as financial advisors, registered investments advisors, etc. The group of bidders will bid to win the right to manage a user's investment portfolio.

By allowing a user to have multiple experienced professional financial bidders compete to bid on managing the user's portfolio, the user will be able save money on having their financial portfolio managed. The program allows for the groups of bidders to participate in a decreasing auction where the lowest bidder is the winning bidder.

To use the present invention, a user fills out a portfolio electronically and verifies his/her portfolio/investment information. The user must submit their portfolio information electronically onto the auction website. The bidders must be registered investment advisors, financial advisors, financial companies to be eligible to bid on a electronically submitted user profile to manage.

The invention requires an electronic passing of a user's portfolio of investments to a group of bidders. The groups of bidders are allowed to bid on the management of a profile electronically.

The present invention will allow only professional bidders to bid on a user's portfolio. By doing so, there will be more trust developed between users and the bidders. Users can also be sure that their portfolios are being managed well. This invention will also ensure that users save money and get the best deal for having their portfolios managed.

### BRIEF DESCRIPTION OF THE DRAWINGS

FIG. 1 is a flow chart showing user registration, approval, and the portfolio directory.

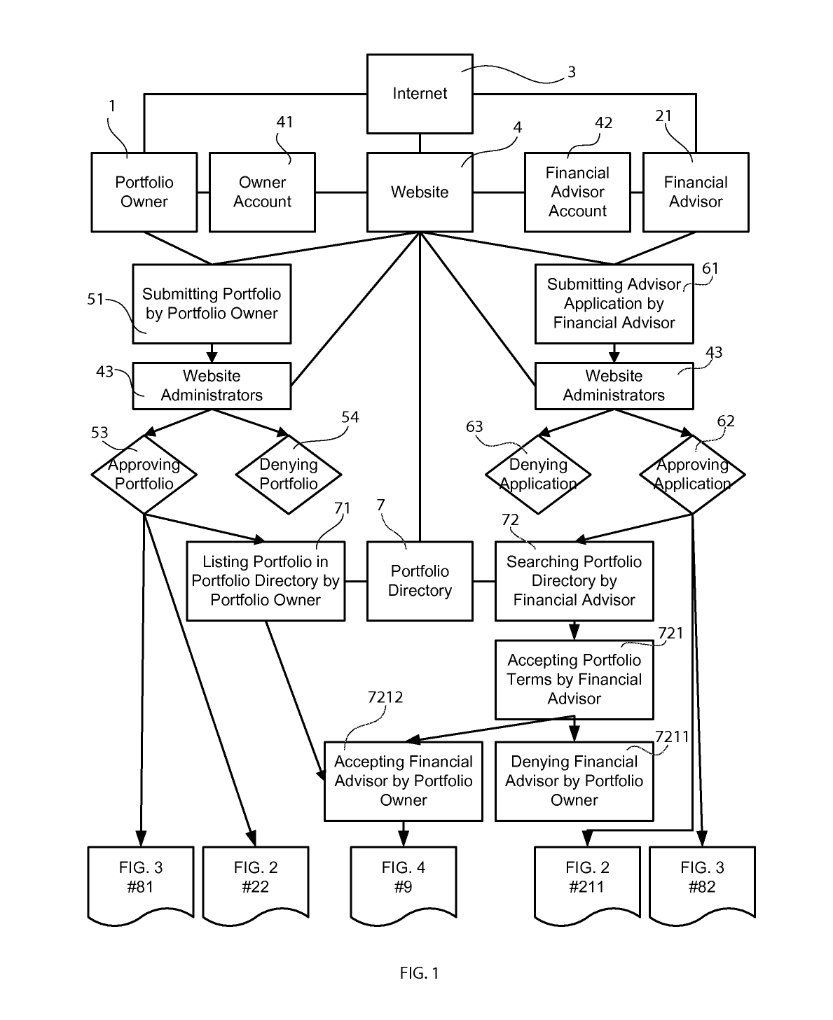

FIG. 2 is a flow chart showing the financial advisor directory.

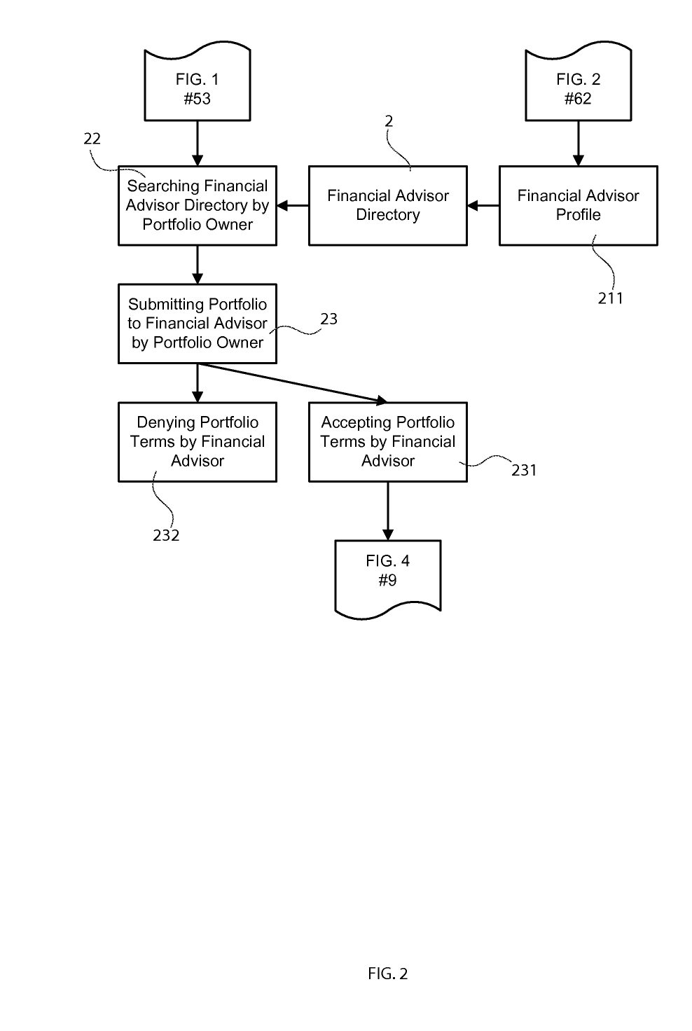

FIG. 3 is a flow chart showing the portfolio marketplace.

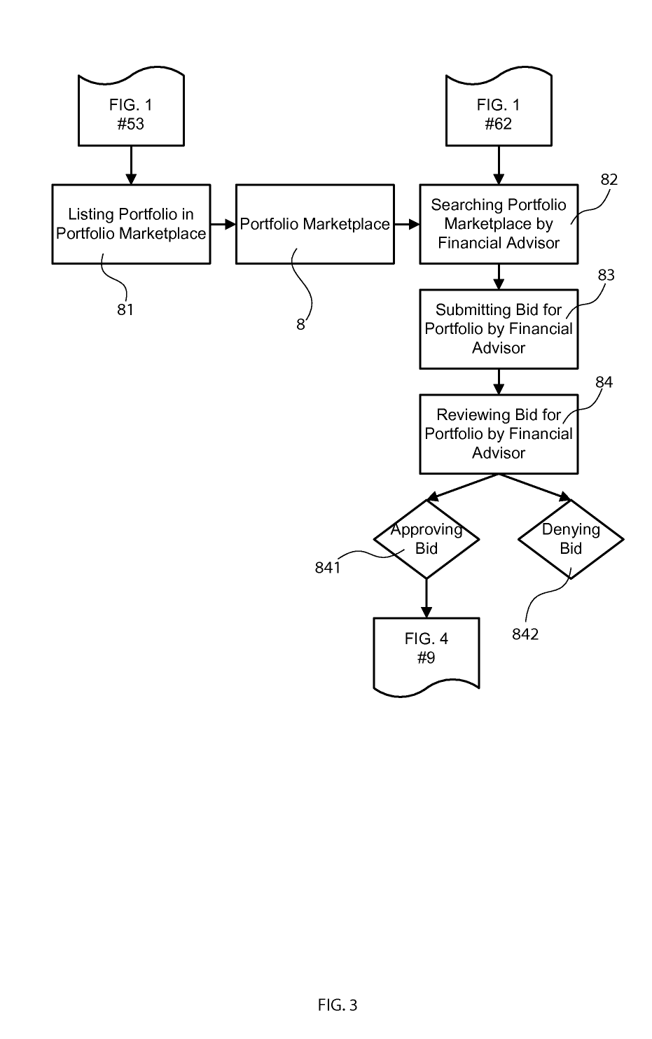

FIG. 4 is a flow chart showing the agreement form process.

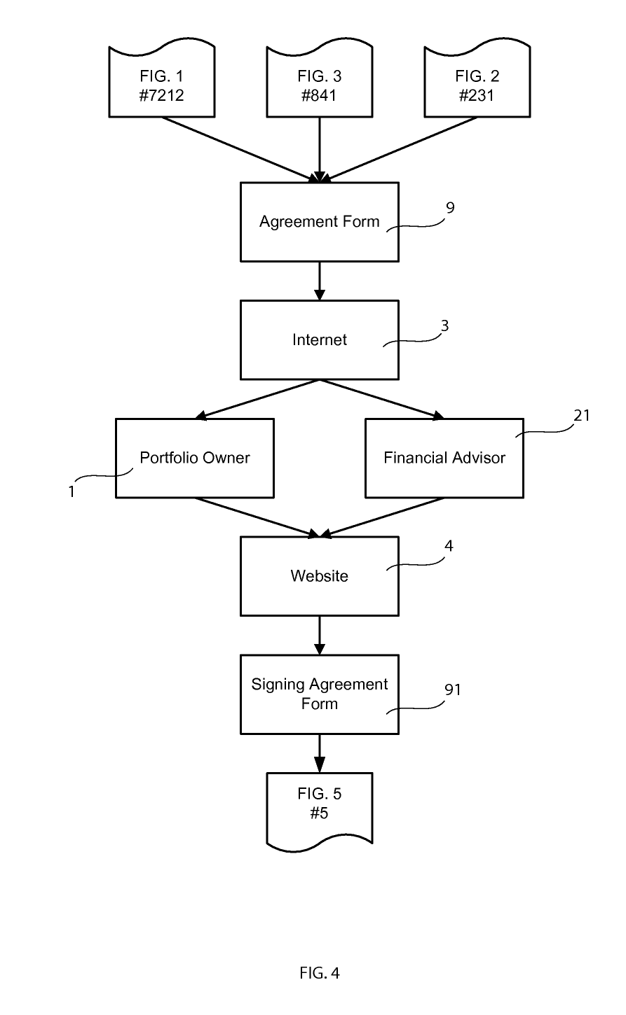

FIG. 5 is a flow chart showing the portfolio transfer process and means of communication.

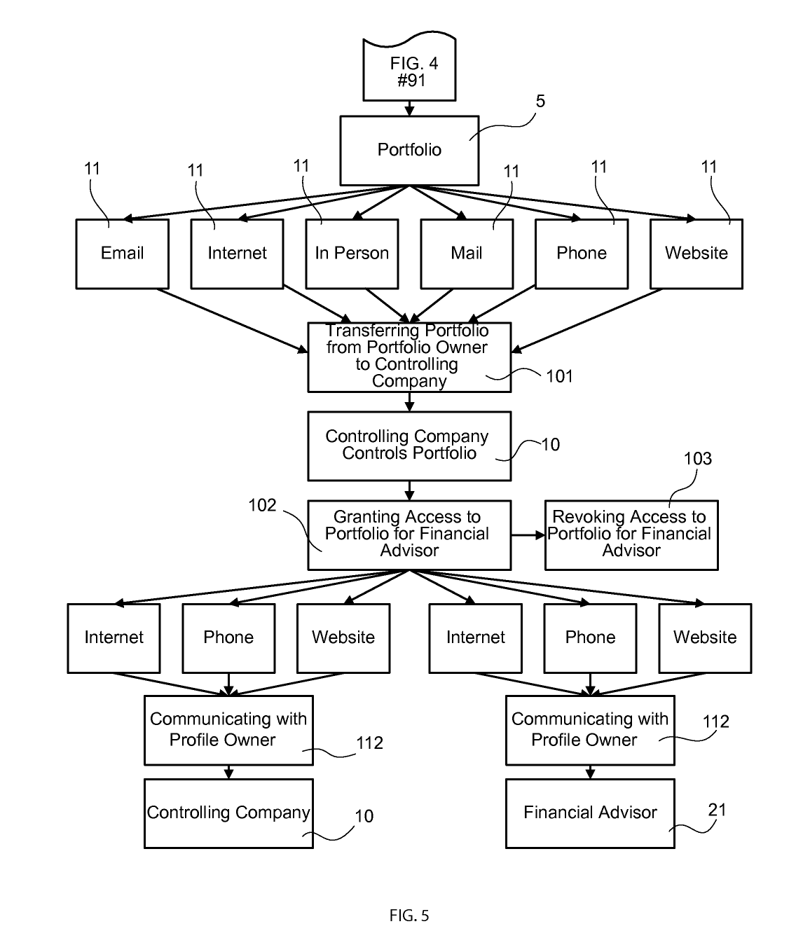

### DETAIL DESCRIPTIONS OF THE INVENTION

All illustrations of the drawings are for the purpose of describing selected versions of the present invention and are not intended to limit the scope of the present invention. A portfolio owner 1 may be any individual or legal entity owning investment vehicles. A financial advisor 21 may be any individual or legal entity providing financial advice, management, or planning including but not limited to financial advisors and registered investment advisors.

A licensed electronic investment portfolio management bidding system comprises of at least one portfolio owner 1, a financial advisor directory 2, at least one financial advisor 21, an internet 3, a website, an investment portfolio, an advisor application 6, a portfolio directory 7, a portfolio marketplace 8, an agreement form 9, and a controlling company 10. The at least one portfolio owner 1 has a portfolio of investments such as bonds, CDs, commodities, futures, IRAs, options, retirement accounts, real estate, stocks, and other investment vehicles. The present invention is run through a website which is accessed by users around the world through the internet 3. The website comprises of an owner 1 account, a financial advisor account 42, and a plurality of website administrators 43. The at least one portfolio owner 1 can access the website through the internet 3 and register to create the owner account 41. The at least one financial advisor 21 can access the website through the internet 3 and register to create the financial advisor account 42.

For the at least one financial advisor 21 to create the financial advisor account 42, the at least one financial advisor 21 must complete and submit the advisor application 61 on the website. The advisor application 6 may ask for personally identifiable information along with questions to collect the background and experience of the financial advisor 21. All information collected by the advisor application 6 through the website is reviewed by the plurality of website administrators 43. The website administrators 43 manage the website's functionality and help ensure that only qualified financial advisors 21 are able to register and be approved for the financial advisor account 42. Upon reviewing the advisor application 6 for a financial advisor 21, the website administrators 43 have the option to approve the advisor application 62 or deny the advisor application 63. If the advisor application 6 is approved by the website administrators 43, the financial advisor account 42 will be opened for the financial advisor 21 and the financial advisor 21 will be able to log-in and access the entire functionality of the website. If the advisor application 6 is denied by the website administrators 43, the financial advisor account 42 will not be opened by the financial advisor 21 and the financial advisor 21 will be unable to log-in and access the entire functionality of the website.

For the at least one portfolio owner 1 to create the owner account 41, the portfolio owner 1 must have an existing investment portfolio 5 and must proceed to submit the investment portfolio 51 to the website. The submitted investment portfolio 5 is reviewed by the plurality of website administrators 43 to ensure portfolio accuracy and to confirm that the portfolio indeed holds the investments stated. If issues arise in which the portfolio owner's 1 investment portfolio 5 cannot be verified, the portfolio owner 1 would be denied by denying the investment portfolio 54 and an owner account 41 would not be created. Subsequently, the portfolio owner 1 would be unable to access the entire functionality of the website. If the submitted investment portfolio 5 is approved by the plurality of website administrators 43 by approving the investment portfolio 53, an owner account 41 would be created for the portfolio owner 1. Subsequently, the portfolio owner 1 would be able to use the owner account 41 to log-in to the website and access the entire functionality of the website.

The portfolio directory 7 is a component of the present invention which is accessible by a portfolio owner 1 with an owner account 41 or a financial advisor 21 with a financial advisor account 42, through the website. The portfolio directory 7 is a list, table, or database of investment portfolios 5 submitted by portfolio owners 1. The portfolio owner 1 is able to list at least one investment portfolio in the portfolio directory 71. Along with the listed investment portfolio 5, the portfolio owner 1 associates a plurality of portfolio terms 2 with the listed investment portfolio 5. The portfolio terms 2 detail the requirements of a financial advisor 21 as decided by the portfolio owner 1. The portfolio directory 7 can be accessed and viewed by at least one financial advisor 21 with a financial advisor account 42. The financial advisor 21 may view the entire list of investment portfolios 5 in the portfolio directory 7 or search the portfolio directory 72 with a search engine and search criteria. The search engine allows a financial advisor 21 to find investment portfolios 5 in the portfolio directory 7 which meet certain criteria in which the financial advisor 21 is interested in possibly managing. Furthermore, the financial advisor 21 may search 72 for investment portfolios which have certain portfolio terms 52 as desired by the financial advisor 21. To clarify uncertainties, the financial advisor 21 may contact the portfolio owner 1 through a means of communication 11. For each investment portfolio 5 found by the financial advisor 21, the financial advisor 21 may accept the plurality of portfolio terms 231 associated with the investment portfolio 5 or deny the plurality of portfolio terms associated with the investment portfolio 5. If the financial advisor 21 accepts the plurality of portfolio terms 231 associated with the investment portfolio 5, the portfolio owner 1 owning the investment portfolio 5 is notified. Upon notification, the portfolio owner 1 may deny 7211 the financial advisor 21 or accept 7212 the financial advisor 21. By denying 7211 the financial advisor 21, the portfolio owner 1 indicates he or she does not want the financial advisor 21 to manage the investment portfolio 5 and the investment portfolio 5 remains listed in the portfolio directory 7. If the portfolio owner 1 accepts 7212 the financial advisor 21, the portfolio owner 1 indicates he or she does want the financial advisor 21 to manage the investment portfolio 5 and the investment portfolio 5 is removed from the portfolio directory 7. Subsequently, the portfolio owner 1 is required to sign the agreement form 9 and transfer the investment portfolio 5 to a controlling company 10.

The portfolio marketplace 8 is a component of the present invention which is accessible by a portfolio owner 1 with an owner account 41 or a financial advisor 21 with a financial advisor account 42, through the website. The portfolio marketplace 8 is a list, table, or database of investment portfolios 5 categorized into various investment criteria. A portfolio owner 1 lists at least one investment portfolio in the portfolio marketplace 81 and may categorize the investment portfolio 5 into an investment criteria category. The portfolio marketplace 8 can be accessed and viewed by a financial advisor 21 with a financial advisor account 42. The financial advisor 21 can view the entire list of investment portfolios 5 in the portfolio marketplace 8 or view a particular category of investment portfolios 5. In additional, the financial advisor 21 can search the portfolio marketplace 8 for investment portfolios 5 which have portfolio terms in which the financial advisor 21 is interested in managing. For each interested investment portfolio 5 found by the financial advisor 21, the financial advisor 21 submits a bid 83. The bid is the fee the financial advisor 21 is willing to accept to manage the investment portfolio 5 for the portfolio owner 1. More than one financial advisor 21 may bid on an investment portfolio 83. With each new bid, the portfolio owner 1 of the investment portfolio 5 receives notification and is able to view the bids. Through the means of communication 11, the portfolio owner 1 may communicate with the at least one financial advisor 21 who has bid on the investment portfolio 83 to clarify questions or interview the financial advisor 21. For each bid received, the portfolio owner 1 approves the bid 841 or denies the bid 842. Denying the bid 842 by the portfolio owner 1 indicates he or she is not interested in having the bidding financial advisor 21 manage the investment portfolio 5 and the investment portfolio 5 remains open for additional bids in the portfolio marketplace 8. Approving the bid 841 by the portfolio owner 1 indicates he or she is interested in having the bidding financial advisor 21 manage the investment portfolio 5 and the investment portfolio 5 is closed for bidding and removed from the portfolio marketplace 8. Subsequently, the portfolio owner 1 is required to sign the agreement form 9 and transfer the investment portfolio 5 to a controlling company 10.

The financial advisor directory 2 comprises of the at least one financial advisor 21. For each financial advisor 21, a financial advisor profile 211 is associated with and viewable through the website by a portfolio owner 1 with an owner account 41. The financial advisor profile 211 displays information about the financial advisor 21 as collected from the advisor application 6 or as updated or entered by the financial advisor 21. The financial advisor profile 211 provides information relevant to the portfolio owner 1 in order to compare the financial advisors 21 and determine their qualifications. The financial advisor directory 2 is accessible and viewable by a portfolio owner 1 with an owner account 41. The portfolio owner 1 browses the financial advisor directory 2 to see registered financial advisors 21 along with their associated financial advisor profiles 211.

Alternatively, the portfolio owner 1 can search the financial advisor directory 2 with the search engine and specifying criteria desired by the portfolio owner 1. When the portfolio owner 1 has found a desired financial advisor 21 in which the portfolio owner 1 is interested in hiring to manage the portfolio 5, the portfolio owner 1 submits the investment portfolio 51 to the desired financial advisor 21. The financial advisor 21 receiving the investment portfolio 5 receives notification and reviews the submitted investment portfolio 5 and associated portfolio terms 2. The financial advisor 21 may accept 231 the portfolio terms or deny 232 the portfolio terms associated with the investment portfolio 5. If the financial advisor 21 denies 232 the investment portfolio terms 52, the financial advisor 21 indicates that he or she is not willing to manage the investment portfolio 5 of the portfolio owner 1. Resultantly, the portfolio owner 1 is notified and has the opportunity to submit the investment portfolio 23 to another financial advisor 21 in the financial advisor directory 2. If the financial advisor 21 accepts 231 the investment portfolio terms 52, the financial advisor 21 indicates that he or she is to manage the investment portfolio of the portfolio owner 1. Subsequently, the portfolio owner 1 is required to sign the agreement form 9 and transfer 101 the investment portfolio to a controlling company 10.

The agreement form 9 is a binding agreement between the portfolio owner 1 and the financial advisor 21 which primarily gives permission to the financial advisor 21 for managing the portfolio owner's 1 investment portfolio 5. The agreement form 9 also serves as a reference of enforcement for both parties to adhere to. Both portfolio owner 1 and financial advisor 21 sign the agreement form 91 electronically through the website 4 of the present invention.

Once the agreement form 9 is ratified, the portfolio owner 1 must proceed to transfer the investments in the investment portfolio 5 to the controlling company 10. The controlling company 10 is a business entity which controls the investment portfolio 5 of the portfolio owner 1 to be managed. Control of the investment portfolio 5 is not directly given to the financial advisor 21 for security reasons so that access to the investment portfolio 5 can be granted 102 or revoked 103 by the controlling company 10 at any time. Once the investment portfolio 5 has been successfully transferred to the controlling company 10 the investment portfolio 5 would be allowed to be managed by the financial advisor 21 specified by the portfolio owner 1 in the agreement form 9. Access to the investment portfolio 5 may be revoked 103 by request of the portfolio owner 1 if he or she no longer wishes to use the services of the selected financial advisor 21. The financial advisor 21 may be an employee of the controlling company 10 or an independent, and would manage and interact with the portfolio owner 1 and their investment portfolio by a means of communication 11 such as but not limited to phone, internet, email, in person, mail, and the website. The means of communication 11 allows communication between the portfolio owner and the financial advisor 112.

Although the invention has been explained in relation to its preferred embodiment, it is to be understood that many other possible modifications and variations can be made without departing from the spirit and scope of the invention as hereinafter claimed.

What is claimed is:

1. A licensed electronic investment portfolio management bidding system comprises,
providing at least one portfolio owner, a financial advisor directory, at least one financial advisor, an internet, a website, an investment portfolio, an advisor application, a portfolio directory, a portfolio marketplace, an agreement form, and a controlling company; and
the website providing an owner account, a financial advisor account, and a plurality of website administrators.

2. The licensed electronic investment portfolio management bidding system as claimed in claim 1 comprises,
submitting the investment portfolio to the website by the at least one portfolio owner;
the investment portfolio providing a plurality of portfolio terms;
approving the investment portfolio by the plurality of website administrators; and
denying a portfolio by the plurality of website administrators.

3. The licensed electronic investment portfolio management bidding system as claimed in claim 1 comprises,
submitting an advisor application to the website by the at least one financial advisor;
approving an advisor application by the plurality of website administrators; and
denying an advisor application by the plurality of website administrators.

4. The licensed electronic investment portfolio management bidding system as claimed in claim 2 comprises,
in response to approving the investment portfolio by the plurality of website administrators, listing at least one investment portfolio in the portfolio directory by at least one portfolio owner; and
searching in the portfolio directory for the at least one investment portfolio by the at least one financial advisor.

5. The licensed electronic investment portfolio management bidding system as claimed in claim 4 comprises,
in response to searching in the portfolio directory, accepting the plurality of portfolio terms by the at least one financial advisor.

6. The licensed electronic investment portfolio management bidding system as claimed in claim 5 comprises,
in response to accepting the plurality of portfolio terms by the at least one financial advisor, denying the at least one financial advisor by the at least one portfolio owner.

7. The licensed electronic investment portfolio management bidding system as claimed in claim 5 comprises,
in response to accepting the plurality of portfolio terms by the at least one financial advisor, accepting the at least one financial advisor by the at least one portfolio owner.

8. The licensed electronic investment portfolio management bidding system as claimed in claim 2 comprises,
in response to approving the investment portfolio by the plurality of website administrators, listing at least one investment portfolio in the portfolio marketplace by at least one portfolio owner;
searching in the portfolio directory for the at least one investment portfolio by the at least one financial advisor;
in response to searching in the portfolio directory for the at least one investment portfolio by the at least one financial advisor, submitting a bid for the at least one investment portfolio by the at least one financial advisor; and
in response to submitting a bid for the at least one investment portfolio by the at least one financial advisor, reviewing the bid for the at least one investment portfolio by the at least one portfolio owner.

9. The licensed electronic investment portfolio management bidding system as claimed in claim 8 comprises,
in response to reviewing the bid for the at least one investment portfolio by the at least one portfolio owner, approving the bid for the at least one investment portfolio by the at least one portfolio owner.

10. The licensed electronic investment portfolio management bidding system as claimed in claim 8 comprises,
in response to reviewing the bid for the at least one investment portfolio by the at least one portfolio owner, denying the bid for the at least one investment portfolio by the at least one portfolio owner.

11. The licensed electronic investment portfolio management bidding system as claimed in claim 2 comprises,
the financial advisor directory providing the at least one financial advisor;
the at least one financial advisor providing a financial advisor profile;
searching the financial advisor directory by the at least one portfolio owner; and
in response to searching the financial advisor directory by the at least one portfolio owner, submitting the at least one investment portfolio to the at least one financial owner by the at least one portfolio owner.

12. The licensed electronic investment portfolio management bidding system as claimed in claim 11 comprises,
in response to submitting the at least one investment portfolio to the at least one financial owner by the at least one portfolio owner, accepting the plurality of portfolio terms by the at least one financial advisor.

13. The licensed electronic investment portfolio management bidding system as claimed in claim 11 comprises,
in response to submitting the at least one investment portfolio to the at least one financial owner by the at least one portfolio owner, denying the plurality of portfolio terms by the at least one financial advisor.

14. The licensed electronic investment portfolio management bidding system as claimed in claim 7 comprises,
in response to accepting the at least one financial advisor by the at least one portfolio owner, signing of the agreement form by the at least one portfolio owner;
in response to signing of the agreement form by the at least one portfolio owner, transferring the at least one investment portfolio from the at least one portfolio owner to the controlling company;
in response to transferring the at least one investment portfolio from the at least one portfolio owner to the controlling company, granting access to the at least one investment portfolio for the at least one financial advisor
providing a means of communication;
communicating with the at least one financial advisor by the at least one portfolio owner; and
communicating with the at least one portfolio owner by the at least one financial advisor.

15. The licensed electronic investment portfolio management bidding system as claimed in claim 14 comprises,
revoking access to the at least one investment portfolio for the at least one financial advisor.

16. The licensed electronic investment portfolio management bidding system as claimed in claim 9 comprises,
in response to accepting the at least one financial advisor by the at least one portfolio owner, signing of the agreement form by the at least one portfolio owner;
in response to signing of the agreement form by the at least one portfolio owner, transferring the at least one investment portfolio from the at least one portfolio owner to the controlling company;
in response to transferring the at least one investment portfolio from the at least one portfolio owner to the controlling company, granting access to the at least one investment portfolio for the at least one financial advisor
providing a means of communication;
communicating with the at least one financial advisor by the at least one portfolio owner; and
communicating with the at least one portfolio owner by the at least one financial advisor.

17. The licensed electronic investment portfolio management bidding system as claimed in claim 16 comprises,
revoking access to the at least one investment portfolio for the at least one financial advisor.

18. The licensed electronic investment portfolio management bidding system as claimed in claim 12 comprises,
in response to accepting the at least one financial advisor by the at least one portfolio owner, signing of the agreement form by the at least one portfolio owner;
in response to signing of the agreement form by the at least one portfolio owner, transferring the at least one investment portfolio from the at least one portfolio owner to the controlling company;
in response to transferring the at least one investment portfolio from the at least one portfolio owner to the controlling company, granting access to the at least one investment portfolio for the at least one financial advisor
providing a means of communication;
communicating with the at least one financial advisor by the at least one portfolio owner; and
communicating with the at least one portfolio owner by the at least one financial advisor.

19. The licensed electronic investment portfolio management bidding system as claimed in claim 18 comprises,
revoking access to the at least one investment portfolio for the at least one financial advisor.
